(19) United States
(12) Patent Application Publication
(10) Pub. No.: US 2011/0298366 A1
(43) Pub. Date: Dec. 8, 2011

(54) HIGH INTENSITY DISCHARGE ARC TUBE AND ASSOCIATED LAMP ASSEMBLY

(75) Inventors: Tamas Panyik, Budapest (HU); Agoston Boroczki, Budapest (HU); Istvan Csanyi, Dunakeszi (HU); Csaba Horvath, Budapest (HU)

(73) Assignee: General Electric Company

(21) Appl. No.: 12/793,398

(22) Filed: Jun. 3, 2010

(51) Int. Cl. H01J 61/32; H01J 9/24

(52) U.S. Cl. 313/634; 445/26

(57) ABSTRACT

The discharge light source includes an arc tube with a discharge chamber having a predetermined location for a metal halide dose or salt pool that minimizes the impact on the light emitted from the light source. The discharge chamber is preferably asymmetric about a second axis that is perpendicular to a longitudinal axis. In one embodiment, the discharge chamber preferably includes first and second generally spheroidal portions of different diameters spaced along the longitudinal axis. The arc tube has different wall thicknesses in yet another arrangement. In a further exemplary embodiment, a portion of a wall that forms the discharge chamber includes a generally concave surface. These features may be used individually or in combination.

### BACKGROUND OF THE DISCLOSURE

Reference is made to commonly owned, co-pending U.S. patent application Ser. No. ______, filed (Attorney Docket 235549/GECZ 2 00957), Ser. No. ______, filed (Attorney Docket 235552/GECZ 2 00980) and Ser. No. ______, filed (Attorney Docket 236625/GECZ 2 00981).

This disclosure relates to an arc tube for a compact high intensity discharge lamp, and more specifically to a compact metal halide lamp made of translucent, transparent, or substantially transparent quartz, hard glass, or ceramic discharge chamber materials. In particular, the disclosure finds application in the automotive lighting field, although it will be appreciated that selected aspects may find application in related discharge lamp environments encountering similar issues with regard to salt pool location and maximizing luminous flux emitted from the lamp assembly. For purposes of the present disclosure, a “discharge chamber” refers to that part of a discharge lamp where the arc discharge is running, while the term “arc tube” represents that minimal structural assembly of the discharge lamp that is required to generate light by exciting an electric arc discharge in the discharge chamber. An arc tube also contains the pinch seals with the molybdenum foils and outer leads (in the case of quartz arc tubes) or the ceramic protruded end plugs or ceramic legs with the seal glass seal portions and outer leads (in case of ceramic arc tubes) which ensure vacuum tightness of the “discharge chamber” plus the possibility to electrically connect the electrodes in the discharge chamber to the outside driving electrical components.

High intensity metal halide discharge lamps produce light by ionizing a fill contained in a discharge chamber of an arc tube where the fill is typically a mixture of metal halides and a buffer agent such as mercury in an inert gas such as neon, argon, krypton or xenon or a mixture of thereof. An arc is initiated in the discharge chamber between inner terminal ends of electrodes that extend in most cases at the opposite ends into the discharge chamber and energize the fill. In current compact high intensity metal halide discharge lamps the molten metal halide salt pool of overdosed quantity often resides in a central bottom location of the generally ellipsoidal or tubular discharge chamber, which discharge chamber is disposed in a horizontal orientation during operation. This is the coldest part of the discharge chamber during lamp operation and consequently is often referred to as a “cold spot” location. The overdosed molten metal halide salt pool that is in thermal equilibrium with its saturated vapor developed above the dose pool within the discharge chamber, and is situated at the cold spot, forms a thin film layer on a significant portion of an inner wall surface of the discharge chamber. This molten metal halide salt pool blocks or filters out significant amounts of emitted light from the arc discharge. The dose pool thereby distorts the spatial intensity distribution of the lamp by increasing light absorption and light scattering in directions where the dose pool sits in the chamber. Moreover, the dose pool alters the color hue of light that passes through the thin liquid film of the dose pool.

Designers of luminaires and optical projection systems such as automotive headlight reflectors associated with these types of lamps must consider these issues when designing the beam forming optics. For example, distorted light rays are either blocked by non-transparent metal or plastic shields, or the light rays may be distributed in directions that are not critical for the application. These distorted rays passing through the dose film are thus generally ignored and because of this the distorted rays represent losses in the optical system since the distorted rays do not take part in forming the main beam of the optical projection system.

In an automotive headlamp application, for example, these scattered and distorted rays are used for slightly illuminating the road immediately preceding the automotive vehicle, or the distorted rays are directed to road signs well above the road. Because of these losses, efficiency of the optical systems is typically no higher than about 40% to 50%.

As compact discharge lamps become smaller in wattage, and also adopt reduced geometrical dimensions, a solution is required with the light source in order to avoid such light collection losses in the optical system. This would result in achieving higher illumination levels along with lower energy consumption of the lighting system.

Thus, a need exists to address the strong shading effect associated with the dose pool, and the impact on performance and efficiency of the optical system designed around the lamp as a result of the uneven light intensity distribution from the lamp.

### SUMMARY OF THE DISCLOSURE

An improved discharge light source positions a molten metal halide salt pool at a desired location in the discharge chamber.

The discharge light source includes an arc tube having a longitudinal axis and discharge chamber formed therein. First and second electrodes have inner terminal ends spaced from one another along the longitudinal axis and each electrode extends at least partially into the opposite ends of the discharge chamber. The discharge chamber is preferably asymmetric about a second axis that is perpendicular to the longitudinal axis.

In another exemplary embodiment, the discharge chamber preferably includes first and second spheroidal portions of different diameters spaced along the longitudinal axis.

The arc tube has different wall thicknesses in yet another arrangement. The different thicknesses of the wall may be at first and second ends of the discharge chamber. Alternatively, along with the uneven wall thickness, the arc tube has principally the same outer diameter all along its length.

Preferably, the chamber is rotationally symmetric about the longitudinal axis in another embodiment.

In a further exemplary embodiment, a portion of a wall that forms the discharge chamber includes a concave inner surface. The concave surface may be located at a first end of the discharge chamber and a generally spheroidal portion formed at a second end of the discharge chamber. Likewise, wall portions of the arc tube may also have different first and second thicknesses at the first and second ends of the discharge chamber in this alternative arrangement.

In still another embodiment, a light transmissive arc tube encloses a discharge chamber. First and second electrodes at least partially extend into the discharge chamber at its opposite ends and are separated along a longitudinal axis by an arc gap. An enlarged dimension first chamber region is located at one end of the discharge chamber and partially surrounds the first electrode, the dimension of the first chamber region being larger than a dimension of a second chamber region around the arc gap.

The enlarged dimension first chamber region is at least partially located axially outward from the inner terminal end of the electrode, that is, towards the seal portion of the arc tube.

A primary benefit of the present disclosure is a controlled location of a metal halide salt pool in a compact high intensity discharge chamber.

Another benefit is that the dose pool is offset towards at least one of the end portions of the discharge chamber and has less impact on the light distribution, thereby resulting in the lamp being more efficient and providing a more even light intensity distribution. In turn, optical designers can develop a more efficient optical projection system.

Still another benefit of providing a preselected liquid dose pool location in the light source is the ability to address the problem of absorbed, scattered and discolored light rays.

Still other features and benefits of the present disclosure will become more apparent from reading and understanding the following detailed description.

### BRIEF DESCRIPTION OF THE DRAWINGS

FIGS. 1-8 are longitudinal cross-sectional views of respective embodiments of the present disclosure.

### DETAILED DESCRIPTION OF THE PREFERRED EMBODIMENTS

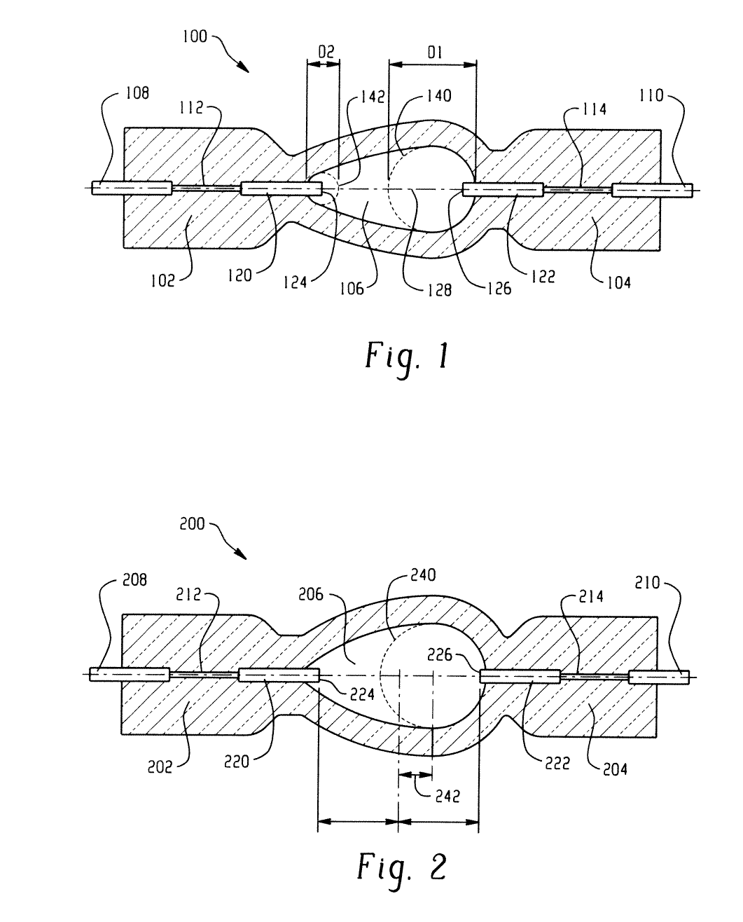

A first embodiment is shown in FIG. 1 and includes an arc tube 100 that includes first and second seal ends 102, 104 disposed at opposite ends of a discharge chamber 106. The arc tube is preferably made of a translucent, transparent, or substantially transparent quartz, hard glass, or ceramic discharge chamber material. Outer leads 108, 110 have outer terminal end portions that extend outwardly from each seal end and with their inner terminal ends terminate within the seal end where the outer leads mechanically and electrically interconnect with conductive plates or foils such as for example molybdenum foils 112, 114, respectively in quartz glass or hard glass arc tube production technology. First and second electrodes 120, 122 have outer terminal ends that are mechanically and electrically joined with, for example, the respective molybdenum foils 112, 114. The electrodes include inner terminal end portions 124, 126 that extend into the discharge chamber 106 at its opposite ends and are separated from one another along a longitudinal axis 128 by an arc gap. As is known in the art, in response to a voltage applied to the first and second outer leads, an arc is initiated or formed between the inner terminal ends 124, 126 of the electrodes. A fill material is sealingly received in the discharge chamber and reaches a discharge state in response to the excitation that generates the arc. Typically, in high intensity metal halide discharge lamps the fill includes metal halides, for example, and may or may not include mercury, as there is an ever-increasing desire to reduce or remove the mercury from the fill of electric discharge lamps.

As described in the Background, a liquid phase portion of the dosing material is usually situated in a bottom center portion of a horizontally operated discharge chamber. This dose pool adversely impacts lamp performance, light color, and has a strong shading effect that impacts light intensity and spatial light intensity distribution emitted from the lamp. In FIG. 1, the discharge chamber is rotationally symmetric about the longitudinal axis 128. The chamber, however, is asymmetric about an axis perpendicular to the longitudinal axis. The particular geometry of the arc tube of FIG. 1 is best characterized and described as a dual-spheroidal portion in which first and second generally spheroidal portions 140, 142 have different diameters D1, D2. The spheroidal portions are aligned with the inner wall surface of the discharge chamber and the centers of the spheroidal portions are located on the longitudinal axis. A preferred ratio of D1/D2 is about 1.0<D1/D2<2.0. As a result of this discharge chamber conformation, the cold spot is still located along a lower portion of the discharge chamber when the lamp is operated in a horizontal position (which is typical for example with an automotive headlamp), but the cold spot is now offset toward one end, namely, toward the end of the discharge chamber with the large diameter spheroidal portion 140 or right-hand end as shown in FIG. 1. The wall thickness of the discharge chamber in this embodiment is generally constant over the entire discharge region between the sealed ends.

FIG. 2 has many similarities to FIG. 1. Consequently, like reference numerals in the “200” series will refer to like components (e.g., arc tube 100 will now be identified as arc tube 200), and the description from FIG. 1 will apply to FIG. 2 unless specifically noted otherwise. The arrangement of FIG. 2 includes only a single spheroidal portion 240 at one end of the discharge chamber 206. A center of the spheroidal portion is offset or eccentric (as represented by reference numeral 242) relative to a mid-point of the arc gap between the inner terminal ends 224, 226 of the electrodes 220, 222. In this particular arrangement, the center of the spheroidal portion is disposed closer to that end of the discharge chamber that has the spheriodal portion (i.e., closer to the electrode terminal end 226). The opposite end, or left-hand end as shown in FIG. 2, has a generally converging conformation that terminates adjacent the terminal end 224 of the first electrode. Again, the wall thickness is generally constant over the peripheral extent of the entire discharge chamber. As a result of this conformation, the cold spot will be located along the bottom region of the spheroidal portion 240, offset to the right bottom region of the discharge chamber of FIG. 2.

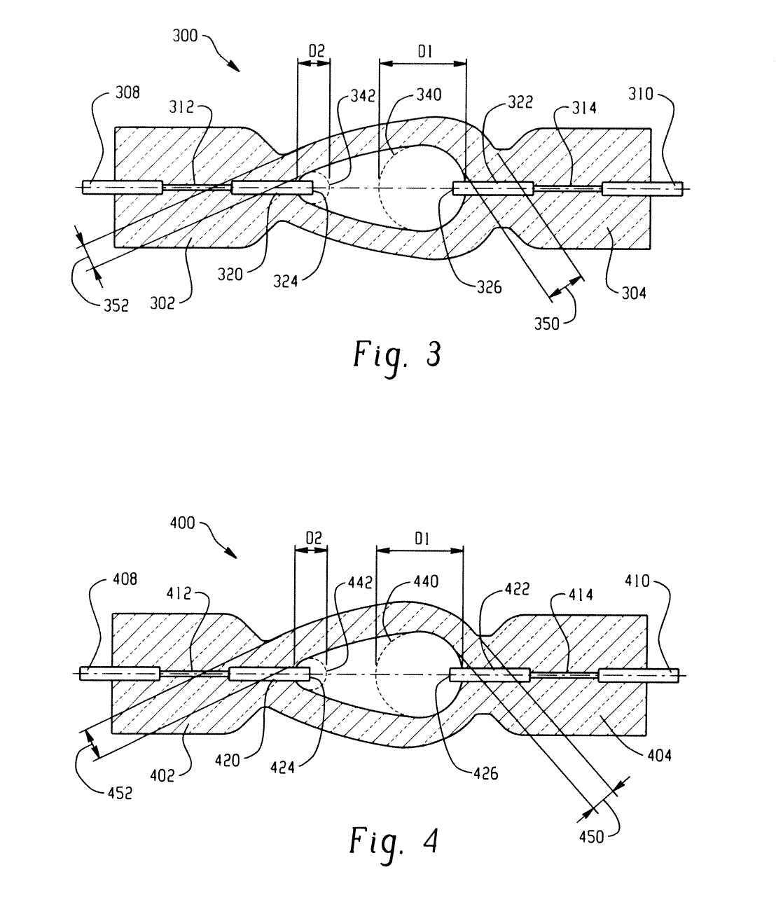

In FIG. 3, like reference numerals in the “300” series will be used to describe like components, while in the embodiment of FIG. 4 (which has similarities to the embodiment of FIG. 3), reference numerals in the “400” series will be used to describe like components. Each of these embodiments includes first and second spheroidal portions 340, 342 and 440, 442 of different diameters. In FIG. 3, the first spheroidal portion 340 has a larger diameter and the smaller diameter spheroidal portion 342 is located at the left-hand end of the discharge chamber 306. It will also be appreciated that the wall thickness is different at different locations along the discharge chamber. In FIG. 3, wall portions 350 (located around the larger diameter D1 of spheroidal portion 340) have a greater thickness than wall portions 352 (located around the smaller diameter D2 of spheroidal portion 342). In this embodiment, the first or thicker wall portion 350 adjacent the first spheroidal portion transitions into the second or thinner wall portion 352 adjacent the second sphere over the longitudinal extent of the discharge chamber. The different wall thicknesses 350, 352 of this configuration, besides the different diameters of the two spheroidal portions, also contribute to the location of the cold spot and consequently the location of the dose pool in the arc tube. Particularly in FIG. 3, where the lamp is operated in a horizontal orientation such as in an automotive discharge headlamp assembly, the cold spot is located at a bottom portion of the first spheroidal portion 340 along the first or thicker wall portion 350.

In contrast, FIG. 4 also includes first and second spheroidal portions 440, 442 of different diameters D1, D2 oriented in a similar fashion to those in FIGS. 1 and 3. Here, however, the location of the different wall thicknesses is reversed relative to the arrangement shown and described with regard to FIG. 3. That is, the thickness of wall portions 450 adjacent the large diameter spheroidal portion 440 is less than the wall thickness of the wall portions 452 disposed adjacent the smaller diameter spheroidal portion 442. Again, as a result, controlled location of the dose pool within the discharge chamber of the arc tube can be predetermined or preselected.

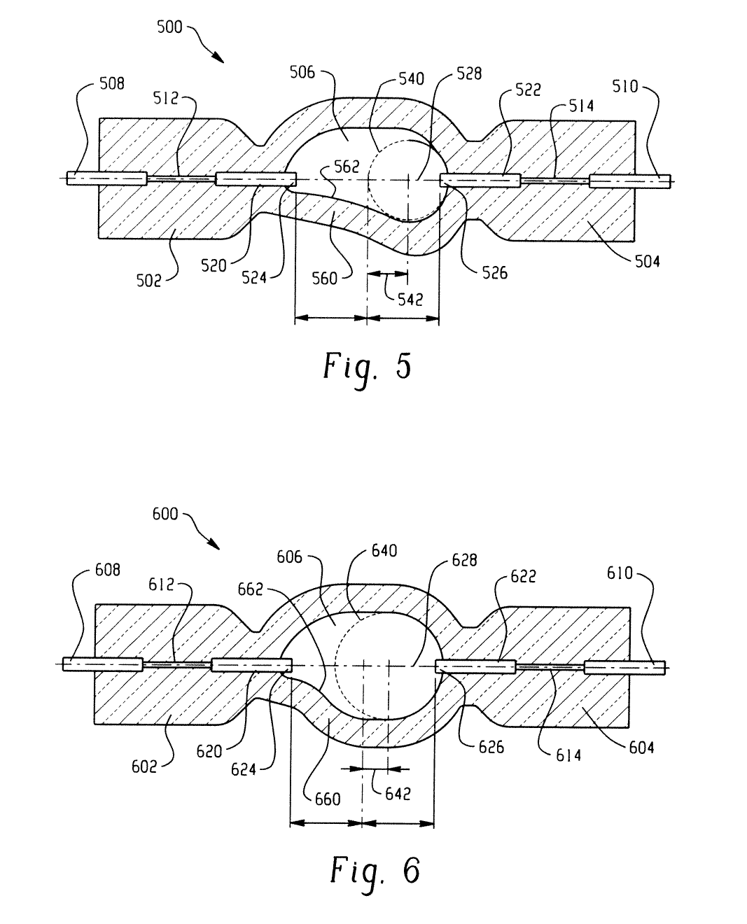

The embodiments of FIGS. 5 and 6 illustrate another manner for controlling the location of the dose pool. Again, like components will be identified by like reference numerals in the “500” and “600” series, respectively. In FIG. 5, a spheroidal portion 540 is defined in discharge chamber 506. In this instance, only a single spheroidal portion is provided, and the spheroidal portion is offset as represented by the eccentric dimension 542, 642 in FIGS. 5 and 6, respectively. The wall thickness throughout the arc tube surrounding the discharge chamber is preferably substantially constant in FIGS. 5 and 6. A primary distinction between these embodiments is the degree of eccentricity, i.e., smaller diameter spheroidal portion 540 and greater eccentricity 542 in FIG. 5 when compared to the embodiment of FIG. 6, which has a greater diameter spheroidal portion 640 and a smaller eccentricity 642.

In each of the embodiments of FIGS. 5 and 6, a bottom region 560, 660, respectively, of the arc tube wall enclosing the discharge chamber 506, 606 is pushed, depressed, or extends inwardly. In this manner, interior surface portion 562, 662 of the wall of the discharge chamber has a generally concave surface. As a result, the cold spot will be located at that region of the bottom in the non-depressed area, i.e., below the lower right-hand portion of the spheroidal portion, in FIGS. 5 and 6 where the dose pool will reside during lamp operation as a result of the increased distance from the arc discharge. Again, this provides for a predetermined or precise location for the dose pool so that an optical designer can adequately address or accommodate the location of the dose pool and more efficiently use light output from the discharge chamber. It is also important to observe that in case of embodiments depicted in FIGS. 5 and 6, the arc tube is no more rotationally symmetric about its longitudinal axis compared to embodiments depicted previously.

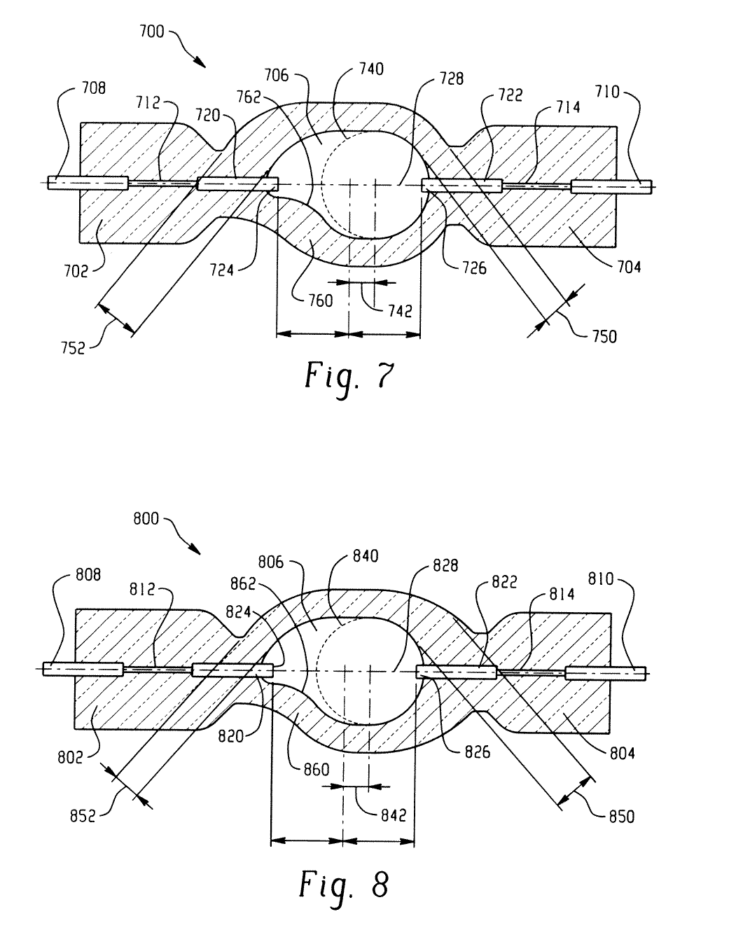

In FIGS. 7 and 8, like reference numerals will refer to like components in the “700” and “800” series, respectively. Like the embodiments of FIGS. 3 and 4, a primary distinction is different wall thicknesses 750, 752 and 850, 852 at different locations of the discharge chamber 706, 806, respectively, to control the location of the cold spot in the discharge chamber, besides the effect of the spheroidal portion on cold spot location. In FIG. 7, the first wall portions 750 along the right-hand edge have a reduced thickness relative to the second wall portions 752 on the left-hand portion of the discharge chamber. In addition, a bottom region 760 of the arc tube wall enclosing the discharge chamber 706 is pushed, depressed, or extends inwardly so that an interior surface portion 762 of the wall of the discharge chamber has a concave surface at one end of the discharge chamber and a non-depressed area, i.e., below the lower right-hand portion of spheroidal portion 740. In FIG. 8, on the other hand, the wall thicknesses are reversed. That is, first wall portions 850 have a greater thickness than the thickness of the second wall portions 852 on the left-hand portion of FIG. 8. This embodiment likewise includes a bottom region 860 of the arc tube wall enclosing the discharge chamber 806 that forms a concave surface along an interior wall surface portion 862 of the discharge chamber at one end of the discharge chamber and a non-depressed area, i.e., below the other end adjacent spheroidal portion 840. Like previously, as a result of the depressed discharge chamber wall at the bottom portion of the discharge chamber, rotational symmetry of the arc tube along its longitudinal axis is also lost in case of embodiments depicted in FIGS. 7 and 8.

The emitted spatial light intensity distribution of the lamps with arc tubes according to the described embodiments becomes more rotationally symmetric, and all of the emitted light can be used by the optical system to form a more intense main beam, for example in better illuminating the road in case of an automotive application. In this way, lamp power consumption can be reduced while still delivering high illumination levels. By way of example, more efficient headlamps applying high intensity discharge lamps of lower energy consumption (e.g., 25 W) can be designed while still keeping road illumination above halogen incandescent levels. It is believed that overall system costs can be reduced approximately 35-40% since no washing and leveling equipment is required by the existing regulations and standards below 2000 lumens lamp luminous flux.

Further, more even lamp performance can be achieved in case of universal burning general lighting applications since the liquid dose pool always resides at the vicinity of at least one of the ends of the discharge chamber irrespective of lamp orientation. In this manner, high intensity discharge lamps with an arc tube according to one of the described embodiments may find wider penetration in indoor applications, and indoor lighting can be of higher quality and efficiency.

The disclosure has been described with reference to the preferred embodiments. Obviously, modifications and alterations will occur to others upon reading and understanding the preceding detailed description. For example, it will be appreciated that in some instances one or more of the different features described above may be used individually or in combination. It is intended that the disclosure be construed as including all such modifications and alterations.

What is claimed is:

1. A discharge light source comprising:
an arc tube having a longitudinal axis and a discharge chamber formed therein;
first and second electrodes having inner terminal ends spaced from one another along the longitudinal axis and each electrode extending at least partially into the discharge chamber; and
the discharge chamber being asymmetric about a second axis perpendicular to the longitudinal axis.

2. The discharge light source of claim 1 wherein the chamber includes first and second generally spheroidal portions of different diameters spaced along the longitudinal axis.

3. The discharge light source of claim 2 wherein wall portions of the arc tube have different first and second thicknesses at first and second ends of the discharge chamber.

4. The discharge light source of claim 2 wherein the discharge chamber is rotationally symmetric about the longitudinal axis.

5. The discharge light source of claim 1 wherein wall portions of the arc tube have different first and second thicknesses at first and second ends of the discharge chamber.

6. The discharge light source of claim 5 wherein a portion of a wall that forms the discharge chamber includes a generally concave surface.

7. The discharge light source of claim 1 wherein a portion of a wall that finals the discharge chamber includes a generally concave surface.

8. The discharge light source of claim 7 wherein the concave surface is located at a first end of the discharge chamber and a generally spheroidal portion is formed at a second end of the discharge chamber.

9. The discharge light source of claim 7 wherein wall portions of the arc tube have different first and second thicknesses at first and second ends of the chamber, wherein the thicker wall portion is located at the first end of the wall that includes the concave surface portion.

10. The discharge light source of claim 7 wherein wall portions of the arc tube have different first and second thicknesses at the first and second ends of the discharge chamber, and the thicker wall portion is located at the second end and the wall portion that includes the concave surface is located at the first end.

11. The discharge light source of claim 1 wherein the discharge chamber is rotationally symmetric about the longitudinal axis.

12. A discharge light source comprising:
an arc tube having a longitudinal axis and a discharge chamber formed therein;
first and second electrodes having inner terminal ends spaced from one another along the longitudinal axis and each electrode extending at least partially into the discharge chamber; and
a dose pool region located adjacent at least one end of the discharge chamber and extending at least partially axially outward of the inner terminal end of the electrode.

13. The discharge light source of claim 12 wherein a wall surface of a central portion of the discharge chamber is closer to the longitudinal axis than a wall surface of the dose pool region.

14. The discharge light source of claim 12 wherein the dose pool region includes first and second portions adjacent each end of the discharge chamber.

15. The discharge light source of claim 12 further comprising at least a tapering portion disposed axially outward of the dose pool region in the discharge chamber.

16. A method of controlling a location of a cold spot in a discharge light source comprising:
providing an arc tube having a longitudinal axis and a discharge chamber formed therein;
orienting first and second electrodes having inner terminal ends spaced from one another along the longitudinal axis and each electrode extending at least partially into the discharge chamber; and
forming the discharge chamber to be asymmetric about a second axis perpendicular to the longitudinal axis.

17. The method of claim 16 further comprising forming wall portions of the arc tube of different first and second thicknesses at first and second ends of the discharge chamber.

18. The method of claim 17 further comprising forming a generally concave surface along a portion of a wall that forms the discharge chamber.

19. The method of claim 18 wherein the concave surface is located at the thicker walled end of the discharge chamber.

20. The method of claim 18 wherein the concave surface is located at the thinner walled end of the discharge chamber.

21. The method of claim 18 further comprising a generally spheroidal portion at the end of the discharge chamber opposite the concave surface.

22. The method of claim 16 further comprising forming a generally concave surface along a portion of a wall that forms the discharge chamber.

23. The method of claim 16 further comprising forming first and second generally spheroidal portions of different diameters at opposite ends of the discharge chamber.
